(19) United States
(12) Patent Application Publication
(10) Pub. No.: US 2002/0194403 A1
(43) Pub. Date: Dec. 19, 2002

(54) Audio video signal processing device

(76) Inventors: Khein-Seng Pua, Hsinchu (TW); Hon-Wai NG, Hsinchu (TW); Hsueh-Chin Lin, Hsinchu (TW); Ming-Hsiang Peng, Hsinchu (TW); Yi-Hsiang Huang, Hsinchu (TW); Eng-Seng Tan, Hsinchu (TW); Chee-Kong Awyong, Hsinchu (TW); Chien-An Chen, Taipei (TW)

Correspondence Address: RABIN & CHAMPAGNE, P.C., Suite 500, 1101 14th Street, N.W., Washington, DC, 20005, US

(21) Appl. No.: 09/880,927

(22) Filed: Jun. 15, 2001

(51) Int. Cl. G06F 13/10

(52) U.S. Cl. 710/62

(57) ABSTRACT

The invention provides an audio video digital signal processing device comprising a plurality of memory interfaces or connecters adapted to receive memory means, a digital signal processor DSP adapted to detect connection of memory means in the memory interfaces and to recognize the audio video format of the stored data, an audio output for audio signal output, a video output for video signal output, and a digital to analog converter and amplifier controlled by the DSP to process audio and video signals from the memory means for output to external audio and video apparatus through the audio output and the video output. The audio and video signals can be processed with a variety of personalized presentation effects based upon users requirements.

### BACKGROUND OF THE INVENTION

1. Field of Invention

The present invention relates to an audio video device, and more particularly to an audio video signal processing device for processing and outputting audio video data of different formats to a variety of audio video output apparatus.

2. Description of Related Art

Following fast development of computer technology, versatile computers with faster operating speeds and smaller sizes are continuously being developed. In order to reduce device dimensions, computers have fewer communication ports and memory means.

Because a computer has a limited number of communication ports, a switching hub may be used when connecting a number of computer peripherals to a computer. Further, various memory cards have been developed and are extensively used for storing data. When reading data from different memory cards, different card readers are used.

However, it is expensive to prepare a variety of card readers for different memory cards. Further, when using a computer with an external memory device, the external memory device must be connected to the computer before turning on the computer because regular memory devices do not support hot swapping.

Therefore, there is a need for an improved audio video digital processing device that is capable of reading, processing and outputting a wide variety of audio and video formats without the need for a host computer.

### SUMMARY OF THE INVENTION

In order to overcome the shortcomings and disadvantages of the conventional design, the invention provides an audio video digital signal processing device, which is capable of reading, processing and outputting a wide variety of audio, and video formats without the need for a host computer.

It is an object of the present invention to provide an audio video signal processing device, which is capable of accessing and transmitting data files stored in a variety of memory cards or memory devices. Such memory devices are, for example, hard disk drives, compact disk drives, dvd drives, and magneto-optical (MO) drives.

According to an embodiment of the present invention, the audio video digital signal processing device comprises a plurality of memory interfaces adapted to receive memory means, a digital signal processor to detect connection of the memory cards to the memory interfaces and the recognize the audio and video format of the stored data, an audio output for audio signal output, a video output for video signal output, and an audio video digital to analog converter and amplifier controlled by the digital signal processor to process audio and video signals for output to external audio video apparatus through the audio and video output.

According to another embodiment of the present invention, the audio video digital signal processor further comprises a universal serial bus interface for connection to an external computer, thus enabling the computer to access data of different memory devices connected to the memory interfaces.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows a system block diagram of the audio video digital signal processing device according to an embodiment of the present invention;

FIG. 2 shows a block diagram showing the audio video signal processing device with memory interface and external audio video output device according to an embodiment of the present invention;

FIG. 3 shows a block diagram showing the audio video signal processing device with memory interface and a computer according to an embodiment of the present invention; and

FIG. 4 shows a block diagram showing the audio video signal processing device with memory interface and memory storage device according to an embodiment of the present invention.

### DESCRIPTION OF THE PREFERRED EMBODIMENTS

In order to overcome the shortcomings and disadvantages of the conventional design, the invention provides an audio video digital signal processing device, which is capable of reading, processing and outputting a wide variety of audio, and video formats.

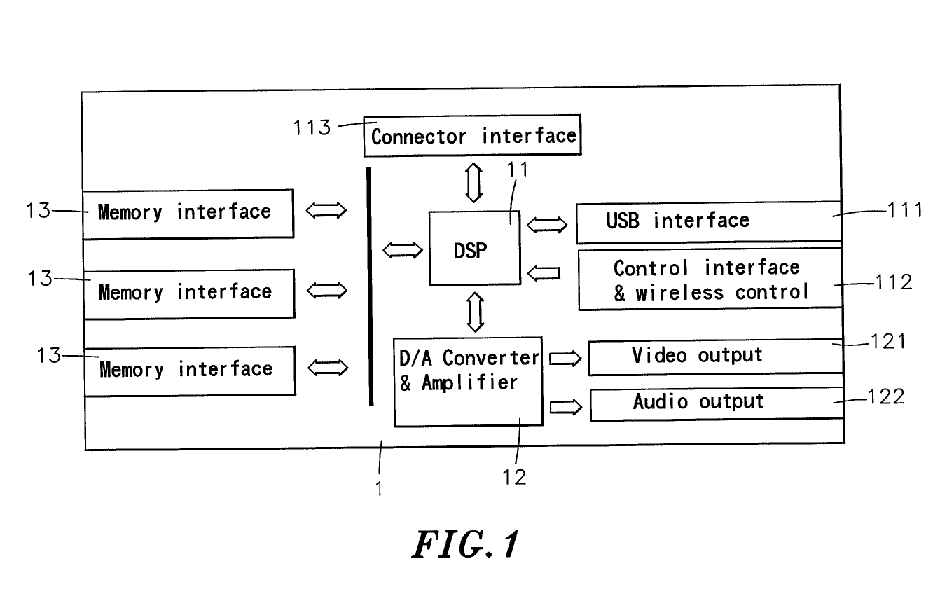

Referring to FIG. 1, which shows a system block diagram of the audio video digital signal processing device according to an embodiment of the present invention. An audio video digital signal processing device 1 is shown comprising a digital signal processor 11, a universal serial bus (USB) interface 111, a control interface or wireless control 112, a connector interface 113, a digital to analog converter and amplifier 12, a video output 121, an audio output 122, and a plurality of memory interfaces or connectors 13.

The memory interfaces 13 are respectively connected to the digital signal processor DSP 11. The DSP 11 is adapted to receive signals from the digital to analog converter and amplifier 12, the USB interface 111, and the connector interface 113, or to transmit signals to the digital to analog converter and amplifier 12, the USB interface 111, and the connector interface 113. The digital to analog converter and amplifier 12 outputs video signals and audio signals to an external audio video output apparatus (for example, TFT-LCD, TV, or any of a variety of apparatus having audio or video input means) 3 through the video output 121 and the audio output 122.

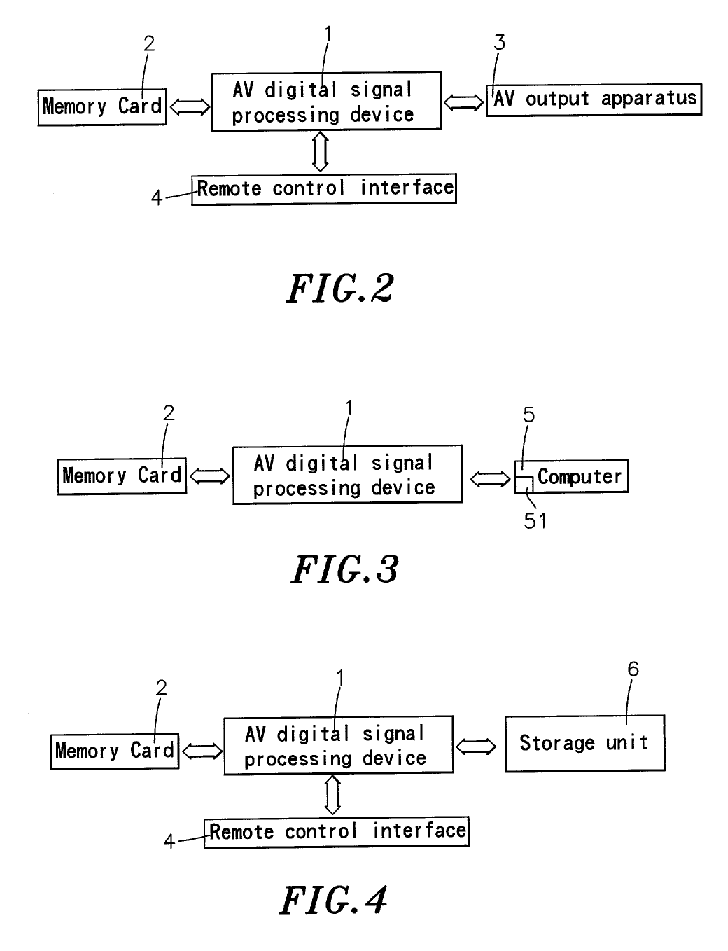

Referring to FIG. 1 and FIG. 2, after insertion of a memory card 2 into one of the memory interfaces or connectors 13, the DSP 11 detects the connection of the memory card 2 in the memory interface 13 and recognizes the memory card type and data format. After recognition of the format of the installed memory card 2, the DSP 11 searches the audio video data file to be played or processed and decodes the compressed format. Then the decoded signal is sent through the digital to analog converter and amplifier 12 to the video output 121 and the audio output 122 for output to an external output apparatus.

Further, the DSP 11 can be controlled to directly access and transmit storage data in the memory cards 2 inserted in the memory interface 13 of the audio video digital signal processing device 1.

Referring to FIG. 1 and FIG. 3, the audio video digital signal processing device is connected to a computer 5 through a USB interface 111. After insertion of a memory card 2 into one of the memory interfaces or connectors 13, the DSP 11 detects the connection of the memory card 2 in the memory interface 13 and recognizes the memory card type and data format. After recognition of the format of the installed memory card 2, the computer 5 transmits signals between the memory card 2 in the memory interface 13 of the audio video digital signal processing device 1 and the memory device (for example, hard disk drive, cd-rom drive, dvd drive, MO drive, etc.) 51.

The memory interface or connectors 13 receive memory cards 2 of various types, for example, MMC, compact flash, smart card, smart media, or micro drive.

Referring to FIG. 1 and FIG. 4, an storage unit (memory card, hard disk drive, cd-rom drive, etc.) 6 can be connected to the connector interface 113 of the audio video digital signal processing device 1, enabling the DSP 11 to transmit data between the storage unit 6 and the memory card 2 inserted into one of the memory interfaces 13.

The audio video digital signal processing device 1 comprises a hot swap function. In addition, by means of the control interface or wireless control 112, the user can control the operation of the audio video digital signal processing device 1 directly, or through an RF or infrared remote controller.

In addition to recognizing and transmitting audio and video data in a variety of formats, the present invention further comprises the ability to process the data and present the data in a variety of audio video presentations. For example, a memory card containing digital pictures in jpg format could be read by the device and then displayed in a slide show. Various transition effects between pictures can also be provided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An audio-video processing device comprising:
a memory card interface for connecting a memory card to the audio-video processing device;
a digital signal processor for processing an audio signal and a video signal;
an audio output for outputting the processed audio signal; and
a video output for outputting the processed video signal;

2. The audio-video processing device of claim 1, wherein the digital signal processor further comprises means for recognizing an audio and video format of the audio and video signal.

3. The audio-video processing device of claim 1, wherein the digital signal processor further comprises means for recognizing the memory card, memory card type, and memory card capacity.

4. The audio-video processing device of claim 1, wherein the audio format is MP3, WAV, CDA, AU, AIF, SND, REX, WMA, MIDI, or MIX.

5. The audio-video processing device of claim 1, wherein the video format is MPEG, AVI, JPG, PNG, BMP, GIF, MOV, or WMA.

6. The audio-video processing device of claim 3, wherein the memory card type is a multimedia card, smart media card, compact flash card, memory stick, or secure digital memory card.

7. The audio-video processing device of claim 1, further comprising:
A high speed interface for connecting the audio-video processing device to a computer.

8. The audio-video processing device of claim 7, wherein the high speed interface is a USB interface or a 1394 interface.

9. The audio-video processing device of claim 1 further comprising a wireless control interface for controlling operation of the audio-video processing device.

10. The audio-video processing device of claim 1 further comprising an interface for connecting an external disk drive to the audio-video processing device.

11. The audio-video processing device of claim 10, wherein the external disk drive is a hard disk drive, a floppy disk drive, a compact disk drive, a DVD disk drive, or a ZIP disk drive.
